(19) United States
(12) Patent Application Publication
(10) Pub. No.: US 2014/0176344 A1
(43) Pub. Date: Jun. 26, 2014

(54) IN LINE INSPECTION METHOD AND APPARATUS FOR PERFORMING IN LINE INSPECTIONS

(71) Applicant: SMART PIPE COMPANY, INC., KATY, TX (US)

(72) Inventors: GARY LITTLESTAR, KATY, TX (US); CHRIS LITTLESTAR, KATY, TX (US)

(73) Assignee: SMART PIPE COMPANY, INC., KATY, TX (US)

(21) Appl. No.: 14/137,273

(22) Filed: Dec. 20, 2013

Related U.S. Application Data
(60) Provisional application No. 61/740,921, filed on Dec. 21, 2012.

(51) Int. Cl. F16L 55/26; G08C 19/00

(52) U.S. Cl. CPC F16L 55/26; G08C 19/00
USPC 340/870.07

(57) ABSTRACT

An apparatus and method for performing inline inspections of pipelines of composite structure installed in a host pipeline or standing alone comprising a multiplicity of sensor/transducers located on or within the pipe structure to measure and record various pipeline properties, an activation/reading/storage device to activate read and collect measurement results from the sensor transducers, an automatic launch and recovery system for the activation/reading/storage device, and a database/storage/analytical device to receive, analyze and interpret results from collected data and transmit appropriate instructions to a pipeline operator or remotely activated system for action. The remote reading of sensor/transducers may be accomplished by a device running through the pipeline or passing over or near the pipeline, where ground-level handheld or wheeled vehicle mounted, fixed wing or rotary aircraft, hovercraft watercraft or satellite based instrumentation can record the location and condition of a pipeline.

This application claims priority from U.S. Provisional Application Ser. No. 61/740921 (the ‘921 application’) filed Dec. 21, 2012. The '921 application is incorporated here by reference.

### BACKGROUND

More than 2.6 million miles of regulated pipelines are in operation in the United States today. The Integrity of these steel pipelines is monitored periodically using Smart Pigs which travel through the internal diameter of these lines measuring wall thickness, dents and corrosion effects as they travel. This is an expensive but somewhat effective process for assessing the integrity of steel pipelines as required by state and federal regulations, and enforced by the Pipeline and Hazardous Materials Safety Administration (PHMSA). These same requirements will also apply to most, if not all, international regulatory bodies.

However, the use of pipes, conduits, pipelines or systems that are non-corrosive, non-metallic reinforced or partially metallic reinforced (referred to as composite pipes herein) in regulated pipelines has been increasing rapidly over the last several years. The techniques described above and used for integrity monitoring of steel pipelines, measurement of wall thickness and corrosion effects, are not effective on composite pipelines. Further, there are significant differences in the failure modes between steel pipelines and composite pipelines. Pipeline operators and regulators have long been seeking an effective method for assessing the integrity of composite pipelines.

This invention relates to novel apparatuses and methods that are single items , but can act as a system that provides an effective means for assessing composite pipeline integrity as desired by pipeline operators, state, federal and international regulatory agencies.

This novel invention comprises multiple parts, whereas the parts can function independently, but can form a system comprising; 1) Multiplicity of discreet sensors embodied into the composite pipeline, which measures and records a package of predetermined engineering data, 2) an internal reader/activator which can measure non sensor related data, or can excite sensors to collect, analyze and report the data from sensors, and 3) a multi-mode internal reader/activator and an automatic launch and retrieve system that may be operated manually, remotely, or automatically, based on data received and analyzed from any sensing or monitoring systems on the pipeline.

This novel invention includes a multi internal reader/activator and an automatic launch and retrieve system that is operated based on data received and analyzed from any sensing or monitoring systems on the pipeline or any control or monitoring systems from a remote location from which the pipeline is operated. This novel invention relates to any type of composite pipes, pipelines and conduits.

### SUMMARY OF THE INVENTION

This present invention is a novel sensor, and sensor data collection system for; collecting data, analyzing data, continuous or periodic measurements and/or testing, diagnostics, and ultimately assessing the integrity of composite pipelines, comprising of strategically placed remotely read sensor/transducers either live or with memory capacity, a remote activation/reading/storage (ARS) device and a database /storage/analytical (DSA) device including novel and proprietary software. The invention also includes a novel system to launch the ARS devices into the pipeline and retrieve the ARS devices from the pipeline, either automatically or manually.

The remotely read sensor/transducers envisioned can include, but are not limited to reading, collecting, and analyzing the following signals: acoustic, vibration, acceleration, strain or force, electrical current, electrical potential, magnetic, flow , fluid/gas velocity, density, ionizing radiation, subatomic particles, mechanical, chemical, optical, thermal, environmental, hydraulic, global positioning data (GPS), conductivity and inductivity.

The types of sensors/transducers envisioned can be, but are not limited to; piezoelectric crystals, piezoelectric ceramics, analog or digital pressure, vibration monitoring sensors, fluid pulse transducers/sensors, temperature, and strain transducers/sensors , radio frequency sensors , geophone, hydrophone, soil moisture sensors, electrochemical sensors, graphene sensors , nano material sensing systems, optical sensors , WISP (Wireless identification and Sensing Platform) sensors, amplifiers and integrated circuit technologies and conductivity, and or inductivity sensing systems.

The devices listed can be used for, but are not limited to measuring predetermined engineering parameters such as; location and movement of pipeline position, temperature, humidity, stress, strain, elongation, dimension, circumferential measurement, ovality of the composite system, gas or fluid composition, flow velocity, presence of hydrates or chemical build up on the composite walls, annulus and pipe pressure, wall loss, chemical degradation, and material properties of the composite system.

The measuring, collecting, and analyzing engineering parameters required for assessing pipeline health and/or integrity is done with miniature transceivers, and/or sensors/transducers, having storage capacity, transmitting and receiving ability and that are built into or attached anywhere on or within the construction of the composite pipe body and can be activated and powered by signals from the ARS device and, when activated, read engineering parameters useful in establishing the integrity of the pipeline transmitting those readings back to the ARS device. Location of the miniature transceivers and/or sensor/transducers circumferentially, axially, and or are built into the composite structure along the pipeline is determined by engineering requirements.

Analytically, these parameters establish the location of the pipeline and any subsequent changes in location, stress, strain in the pipe wall at a given position in the pipeline, ovality of the pipe as a function of given position in the pipeline, the general configuration of the pipeline, and any other required engineering parameters, and presence of any leaks and potential for short term and/or long term pipe system failure.

The ARS device may be comprised of, but not limited to, a power source, an integrated circuit with antenna, transceiver, laser, camera, optical devices, robotic arms, treads, wheels, gearing or hydraulic and/or mechanical rotating systems, tethering devices, fluid and/or gas driven venting systems, propellers, propulsive nozzles, wings, fins or legs. and data storage (memory) section. This device is passed through, over or near the pipeline sending signals with sufficient power to activate the sensor/transducers and allow them to measure engineering parameters and transmit the measurement results back to the ARS device which receives and stores them as a function of time, or in relation to a discreet position along the pipeline and can also take interior measurements, photo and video images and collects samples of gas, fluid and/or any solids present, The ARS device may have connectivity provided by metallic or non-metallic wires that are integral to the reinforcement or are separately installed within the pipe wall to provide connectivity. Likewise, the ARS device may have the power source and/or connectivity provided by proximity to a metallic host pipe having electrical properties resultant from an operating Cathodic Protection system

The ARS device may be configured as a robotic device, or sphere, or ball, or elongated bullet, or of a funnel or closed funnel geometry, or a tethered apparatus or by a self-contained propulsion system, for passage through the inside diameter of the pipeline, or as a vehicle mounted device for passing over or near the pipeline. “Vehicle” in this document indicates a hand held device, a device mounted on a hand pushed cart rolling on the surface of the ground or a powered vehicle such as a hovercraft, wheeled vehicle, tracked vehicle, helicopter or airplane or glider, or “lighter-than-air ” aircraft, or satellites. The size, frequency and output of the power source and transceiver will vary depending upon the configuration of the sensor/transducers and ARS device and its expected proximity to the pipeline.

The ARS memory may be in the form of any electronic data storage device or combination of such devices with sufficient capacity for the anticipated amount of data expected to be accumulated over the length of pipeline to be examined. The predetermined engineerimg parameters or data to be collected by the various sensors/transducers may include, but not be limited to; location and movement of pipeline position, location of the sensor relative to the pipeline, temperature, humidity, stress, strain, elongation and ovality of the composite system, gas or fluid composition, flow velocity, presence of hydrates or chemical build up on the composite walls, annulus and pipe pressure, wall loss, chemical degradation, material properties of the composite system, and the engineering parameter(s) read.

The automatic launch and recovery system (ALRS) for the ARS consists of two or more discreet locations along the pipeline as determined by engineering, where an ALRS launcher and an ALRS receiver are installed.

The ALRS launcher comprises a chamber that may hold multiple ARS units and will be sealed so that the ARS units can be launched into the system without having to open the pipeline system. The ALRS launcher comprises a fill chamber operated by a pneumatic, or hydraulic, or electrical valve. The ARS unit to be launched is dropped by gravity into the launch chamber after opening the uppermost valve (Launch chamber valve), which is then closed. A lower valve (stream chamber valve) is then opened to equalize the launch chamber to pipeline flow pressure. Once the launch chamber is equalized, the ARS is pushed into the pipeline stream by a nitrogen or fluid charge that creates a pressure differential across the ARS pushing it into the pipeline stream. As the ARS passes from the launch chamber into the pipeline a mechanical or electronic switch is triggered by the ARS, which automatically closes the stream chamber valve. The stream chamber valve is then bled down to 0 psi. This is a full cycle and the launching of a second or subsequent ARS would be a repeat of the cycle.

The ALRS receiver comprises a chamber that will hold multiple ARS units and will be sealed so that the ARS units can be retrieved from the system. The ALRS receiver comprises a receiving chamber and a recovery chamber operated by pneumatic, or hydraulic, or electrical valves. During the running of and prior to the receiving of the ARS, the lower most valve, furthest from the pipeline flow, (recovery chamber valve) is in a closed position. The upper most valve, furthest from the pipeline flow, (retrieval chamber valve) is opened and the pressure is equal to the pipeline stream.

Upstream of the retrieval chamber is a mechanical or electronic switch in the pipeline which is triggered by the passing of the ARS. When the switch is triggered, a separate pneumatic, or hydraulic, or electrical valve (pressure differential valve) on the outside of the retrieval chamber is opened to a vessel or to atmosphere that enables a sufficient flow volume to maintain a lower pressure (minimum differential pressure of 1 psi) in the recovery chamber for a sufficient time to enable the ARS to flow into the retrieval chamber. As the ARS passes into the retrieval chamber it triggers another mechanical or electrical switch that closes the retrieval chamber valve and then the pressure differential valve, isolating the retrieval chamber from the pipeline flow. The recovery chamber valve is then opened, and the pressure differential valve is opened to push the ARS into the recovery chamber. A flapper in the recovery chamber closes after the ARS passes through and the differential pressure valve closes. The vessel for differential pressure is reduced to 0 pressure and, if required, drained of any fluids in preparation for the next ARS retrieval.

The above systems can also be operated manually.

The database/storage/analytical (DSA) device is a portable or fixed computer based system with novel system specific software. The DSA receives data from the ARS unit through wireless or cable connectivity means, stores in an accumulated data base, and processes the data. Processing the data involves the use of the novel software to calculate desired engineering values that are used to establish the integrity of the pipeline and identify any changes and/or anomalies from the baseline or previous inspection.

Comparison of the calculated values with prior values indicate any change in the pipeline parameters, such as, but not limited to; pipeline operating temperature and humidity, change in ovality and increases in hoop and/or axial strain and elongation of the pipe. These are compared against pre-determined limits to establish pipeline integrity.

### NOVELTY OF THE INVENTION

Prior art for steel pipeline integrity inspection has been based upon the primary mode of failure of metallic pipes. That is, measurement of the effects of corrosion/erosion resulting in a loss of wall thickness and providing information necessary to:

Establish the need for pipeline replacement,

Establish the need for a reduction in functionality of the pipeline

Demonstrate the integrity of the pipeline

The present invention provides a novel non-intrusive, non-destructive method and apparatus for obtaining the data necessary to identify near term failure modes, predict longer term failure modes of composite pipelines and to identify other anomalies leading to premature failure of the pipeline. The collected data provides objective information which allows assessment of the integrity of the pipeline considering time dependent failures which can be used to address the needs of the pipeline operator and regulatory bodies such as PHMSA and/or any other regulatory bodies.

The present invention allows for the configuration of the apparatus such that the sensor/transducers are passive, power assisted passive, semi passive, active or in combinations of such configurations. The sensor/transducers can be located within the pipe structure such that they are protected from most external events and are designed to operate at any pre-designated period of time, and can be designed to operate for at least 50-years without maintenance.

The novel sensor/transducers are designed to detect and measure, for example, bi-axial strain (strain in two perpendicular directions), temperature, humidity, chemical composition and provide the pipeline's identification and location of the sensor/transducer with respect to the pipeline. Other specialty sensor/transducers may be used for specific measurements/applications. Each sensor/transducer may have a memory storage capability and a transceiver/antenna built-in to allow receiving activation signals from the ARS unit and transmitting the results of measurements back to the ARS. Strain, and especially changes in strain over time, are key data for assessing the pipes integrity. Sensor/transducers operate independently of each other such that a failure of one does not affect the working of adjacent sensor/transducers.

In one novel configuration the ARS unit is designed to be launched into the pipeline and self-propelled, carried by flowing fluid and/or gas, or pulled through the pipeline via tether, or magnetics, or robotics engaging the sensor/transducers as it passes. In this configuration, the ARS contains an internal power source, a transceiver/antenna and memory or storage section and device for direct downloading of collected data. The power source can be a battery, or any other source of power suitable for the intended purpose. The ARS transceiver/antenna is designed to operate in the same frequency range as the sensor/transducers. The memory/storage section contains adequate capacity to store the data over the length of pipeline to be inspected, and also based on time parameters where the storage can hold sufficient data for analysis against previous measurements.

In another novel configuration the ARS unit described is handheld, mounted on a hand pushed cart and pushed along the ground over the pipeline reading the sensor/transducers as it moves past them or mounted in or is mounted on a powered vehicle such as but not limited to a wheeled vehicle, a tracked vehicle, a hovercraft, a water vehicle, a flying vehicle such as but not limited to a helicopter or fixed wing airplane, or “lighter-than-air vehicle, or satellite. In this configuration an external source of power may be provided. Additionally, selected discreet segments of the line or “spot checks” can be made by external ARS unit.

The novel DSA apparatus is a computer based system that includes connectivity to the ARS and may also send information directly to the operator's pipeline Supervisory Control And Data Acquisition (SCADA) system. The DSA may be mobile or fixed. The mobile configuration may be mounted on the push cart or other vehicles as described above. In both configurations the DSA is controlled by innovative specialty software that processes the recorded data, analyzes it using specific for purpose software and compares the results with prior results and against pre-determined values. When values are outside allowable limits a warning may be transmitted to the pipeline operator's SCADA or any other control system and when warranted, pipeline control devices may be activated, either by SCADA or any other control system or by the ARS systems.

The novel ARS apparatus can also be a computer based system that includes connectivity to the sensors/transducers as well as send information directly to the operator's pipeline Supervisory Control And Data Acquisition (SCADA) system or any other control system. In this configuration ARS is controlled by innovative specialty software that processes the recorded data, analyzes it using specific for purpose software and compares the results with prior results and against pre-determined values. When values are outside allowable limits a warning may be transmitted to the pipeline operator's SCADA system or any other control system and when warranted, pipeline control devices may be activated, either by SCADA system or any other control system, or by the ARS apparatus itself.

The novel automatic launch and recovery system (ALRS) can be controlled with the pipeline operator SCADA system or any other control system, and also can be controlled by the ARS apparatus itself when it is operated as a separate computer mode.

### BRIEF DESCRIPTION OF THE DRAWINGS

FIG. 1 is the cross sectional presentation of the pipeline engaged with the sensors in different positions and under the variety of angles, within a composite pipeline; showing launching and receiving stations.

FIG. 2 is a depiction of the recorded data in one form of the presentation by the ARS or DSA reading instrumentation.

FIG. 3 depicts non-dimensional sketches of the ARS “data retrieval pod” and “data retrieval ball” implying the variety of sizes and shapes that are possible.

FIG. 4 is an isometric depiction of a composite pipe structure where the components of the pipe materials have built in sensor/transducers and the sensor/transducers are independently attached or those which can be applied and built within the material itself. There are also nano sensor/transducers, WISP Sensors and graphene sensors included as part of the materials of construction. The nano enhanced coating, adhesive and filler materials are also included. Such systems have a high strength and resilience that can sustain high pressures, temperatures and impacts. FIG. 4a shows a segment of a fully expanded cross section of the composite pipe with an inserted sensor/transducer.

FIG. 5 is a reduced “C” shape alongside a fully expanded shape , among other shapes for the reduction of the composite pipe used as a structural form for easy insertion into an existing pipeline, showing the covers as a protection and also available as mentioned in FIG. 4.

FIG. 6 shows the detail of the installed pulling tapes and the fabric composition with built in components for sensors and material built in sensors such as nano fibers and graphene materials.

FIG. 7 is the detail of the machine showing the patented application by helical means of the tapes as overlays over a core pipe as a shape and size control member of the composite pipe.

### DETAILED DESCRIPTION OF THE INVENTION

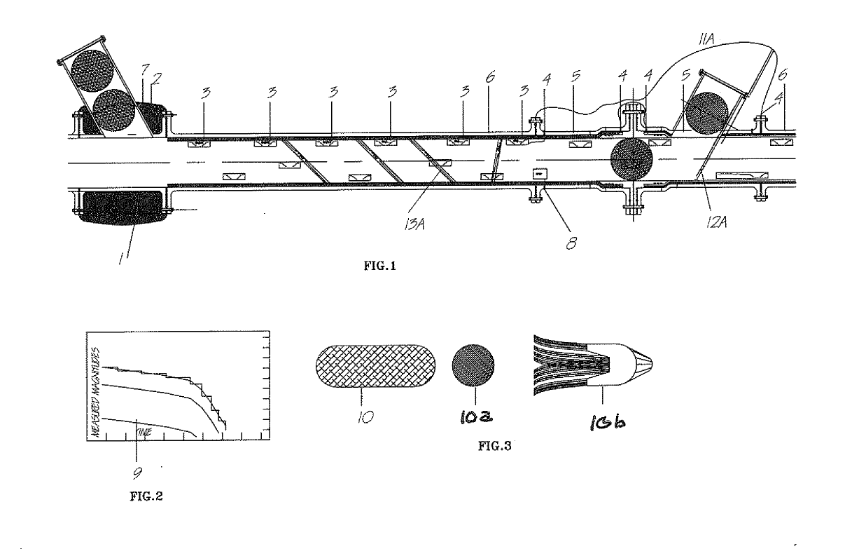

FIG. 1 shows a cross sectional presentation of a typical pipeline with the inventive system and method for monitoring pipelines installed along with novel automatic launch and recovery system (ALRS) for an activation/reading/storage device (ARS). In FIG. 1, a host pipeline 6 is fitted with a launching fitting 1 having an ARS launcher 2, an adapter spool piece 5 with a protective enclosure 7, an ALRS receiver 11A, and a retractable gate 12A. Also shown are sensor/transducers 3 in various positions 13A. A wired sensor 4 is shown as well as a radio frequency identifier RFID 8.

It is intended that the inventive system and method be applicable to a length of pipeline with an existing technology pig retrieval fitting adapted for use with composite piping and ARS unit at the opposite end of the pipeline.

It is also intended that the inventive system and method be applicable on re-habilitation projects for a host metallic pipeline and for pipes, conduits, pipelines or systems that are non-corrosive, non-metallic reinforced or are partially metallic reinforced that are either inserted into a steel “host pipe” or deployed as a stand alone composite pipe.

The sensor/transducers 3 are positioned axially and circumferentially, or manufactured in-situ within the non-metallic or partially metallic reinforced thermoplastic composite pipe wall layers in strategic locations where:

The sensor/transducers 3 are passive—there is no local power.

The sensor/transducers 3 are semi-active modified radio frequency identifier devices that have limited local power such as a battery or power generator.

The sensor/transducers 3 are powered or active-that is with full local power or hardwired into the system.

FIG. 2 depicts a graphical reading 9 or electronic presentation from the ARS or DAS instrumentation.

FIG. 3 shows two possible cross sections of ARS Units, including the “data retrieval pod” 10, the “data retrieval ball” ARS unit 10a and a self propelled reader 10b.

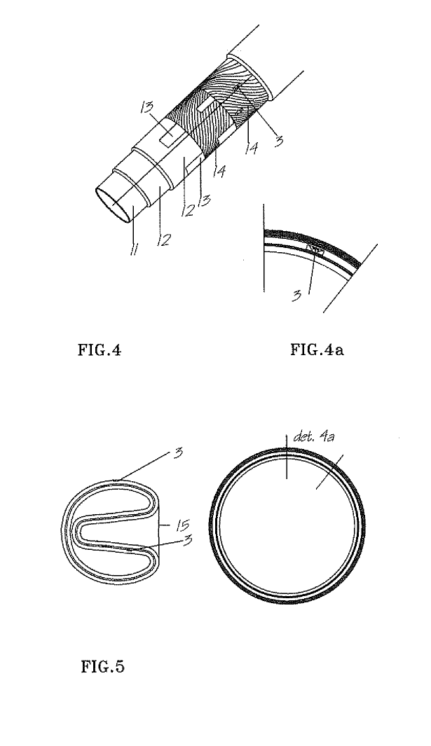

In FIG. 4 an isometric representation of one type of high strength light weight composite pipe in one form of manufacturing is depicted with a pressure barrier core pipe 11, reinforcement fabric strength layers 12 helical and circularly wound as per the design requirements for strength with sensors embedded within the fabric as required, high strength pulling tapes 13 with imbedded sensors as required, and fiber tows 14 with embedded sensors.

FIG. 5 shows a cross section formed in one possible shape for reduction of the pipe diameter with sensor/transducers 3 embedded under a protective covering 15 required for some installations in a host pipe. Alongside the formed shape is shown a fully expanded shape from which a section is marked and depicted in FIG. 4a to show the placement/insertion of a sensor/transducer 3 in the composite wall structure.

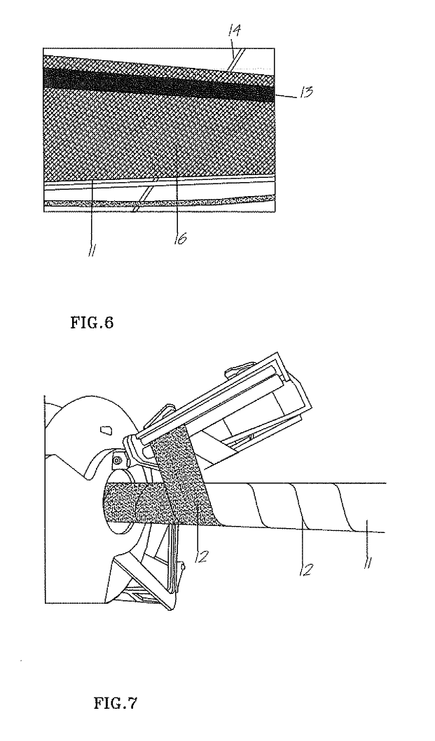

FIG. 6 shows the detail of the high strength pulling tapes 13 and the reinforcing fabric 16 woven with nano fibers as sensors as a part of the fabric composition capable of functioning within the structural fabric. Other types of sensors can include; piezoelectric sensors, transducers, radio frequency sensors, graphene sensors, nano material sensing systems, WISP sensors, optical sensors and conductivity sensing.

In FIG. 7 the machine used for one method of pipe construction is shown applying the reinforcement fabric layers 12 on the pressure barrier core pipe 11.

What is claimed is:

1. An apparatus for performing inline inspections of pipelines of composite structure installed in a host pipeline or standing alone comprising a multiplicity of sensor/transducers located on or within the composite pipe structure to measure and record various pipeline properties, an activation/reading/storage device to activate read and collect measurement results from the sensor transducers, an automatic launch and recovery system for the activation/reading/storage device, and a database/storage/analytical device to receive, analyze and interpret results from collected data and transmit appropriate instructions to a pipeline operator or remotely activated system for action.

2. The apparatus of claim 1 wherein the sensor/transducers are located on or within the walls as a part of the reinforcement of the composite pipes.

3. The apparatus of claim 1 wherein the sensor/transducers are networked or connected to each other.

4. The apparatus of claim 1 wherein the sensor/transducers are not networked.

5. The apparatus of claim 1 wherein the sensor/transducers have no local power source and considered as passive devices.

6. The apparatus of claim 1 wherein the sensor transducers have connectivity to a power source and considered as active devices.

7. The apparatus of claim 1 wherein the sensors/transducers are modified to operate on radio frequencies that have limited local power and are considered as semi-active devices.

8. The apparatus of claim 1 wherein the sensor/transducers are a combination of passive, semi-active and active devices.

9. The apparatus of claim 1 wherein the sensor/transducers are nano-technology materials, Nano Electro-Mechanical Systems or Micro Electro-Mechanical Systems devices applied to the composite pipeline, or are included as a component or constructed within another component of the composite pipeline.

10. The apparatus of claim 1 wherein the sensor/transducers are WISP sensors.

11. The apparatus of claim 1 wherein the sensor/transducers are optical sensors.

12. The apparatus of claim 1 wherein the sensor/transducers are graphene materials, or are included as a component or constructed within another component of the pipeline.

13. The apparatus of claim 1 wherein the sensors/transducers include, but are not limited to reading, collecting, and analyzing the following signals: acoustic, vibration, acceleration, strain or force, electrical current, electrical potential, magnetic, flow , fluid/gas velocity, density, ionizing radiation, subatomic particles, mechanical, chemical, optical, thermal, environmental, hydraulic, global positioning data (GPS), conductivity and inductivity.

14. The apparatus of claim 1 wherein the sensors/transducers can be, but are not limited to; piezoelectric crystals, piezoelectric ceramics, analog or digital pressure, vibration monitoring sensors, fluid pulse transducers/sensors, temperature, and strain transducers/sensors , radio frequency sensors , geophone, hydrophone, soil moisture sensors, electrochemical sensors, graphene sensors , nano material sensing systems, optical sensors , WISP (Wireless Identification and Sensing Platform) sensors, amplifiers and integrated circuit technologies and conductivity, and or inductivity sensing systems.

15. The apparatus of claim 1 installed in a host pipeline wherein connectivity is provided by metallic or non-metallic wires that are integral to the reinforcement or are separately installed within the pipe wall to provide connectivity.

16. The apparatus of claim 1 installed in a host pipeline wherein the power source and/or connectivity is provided by proximity to a metallic host pipe having electrical properties resultant from an operating Cathodic Protection system.

17. The apparatus of claim 1 wherein modified radio frequency identifiers sensor/transducers provide for the identity/location of the device position of the sensor on the pipe and include separate sensors/transducers for measurement of engineering properties comprising pressure, humidity, temperature, strain (bi-axial), fluid or gas composition, temperature, dimension, circumferential measurement, ovality and flow rate.

18. The apparatus of claim 1 wherein the sensor/transducers and activation/reading/storage devices are tuned to the same operating frequency for each application.

19. An activation/reading/storage device configured to pass through the pipeline using internal propulsion means, driven by fluid and or gas flow or pulled by mechanical means, comprised of a power source and transceiver that activates and powers sensor/transducers and receives a resulting transmission from sensor/transducer storing the data received in a memory-storage area with the capability to wirelessly or cable transfer the stored data to a data storage and manipulation device.

20. The activation/reading/storage device of claim 19 wherein the power source is any suitable source of energy including but not limited to a battery, battery pack, proximity to the host pipe with operating Cathodic Protection system, generator, invertor, micro-nuclear power plant and the like.

21. The activation/reading/storage device of claim 19 wherein the transceiver is an integrated circuit with antenna tuned to the same radio frequency identifier frequency as the sensor/transducers

22. An activation/reading/storage device configured as a hand held or vehicle mounted device to pass over a pipeline comprised of a power source and transceiver that activates and powers sensor/transducers and receives a resulting transmission from them storing the data received in a memory-storage area with the capability to wirelessly or cable transfer the stored data to a data storage and manipulation device

23. The activation/reading/storage device of claim 22 wherein the vehicle is manually moved.

24. The activation/reading/storage device of claim 22 wherein the vehicle is powered by but not limited to a hovercraft, water craft, two or more wheeled vehicle, a tracked vehicle, a rotary aircraft or a fixed wing aircraft, satellite or the like.

25. The activation/reading/storage device of claim 22 wherein a database/storage/analytical device is mounted on the vehicle and connected to the activation/reading/storage device.

26. A database/storage/analytical device is a novel computer based system comprised of hardware and software that contains the interpretation programs to compile, analyze and compare recorded data, furnish the results to operators and/or a pipeline supervisory control and data acquisition system, react upon the results, inform from the results, substitute and correlate the results, offer the readings for an operators action, and provide history of the pipeline and conduits over the life of the subject pipeline.

27. The device of claim 26 wherein the device has a wireless input/output port for communications with other devices.

28. The device of claim 26 wherein analytical software includes provisions for analysis of composite pipes including the use of a material properties database for strips, wires, fibers, fabrics and polymers including actual test data for the materials used in fabrication of the composite pipe being used.

29. A method for establishing the integrity and/or change in integrity of a composite pipeline with non-contact reading sensor/transducers in or on the pipe body wall, comprising the steps of: passing an activation/reading/storage device through the pipeline; compiling and analyzing readings and comparing results of analyses with prior analyzed readings and a baseline reading to identify any changes in position, temperature, stress and/or strain level.

30. The method of claim 29 where the activation/reading/storage device accumulates data and later transfers the data to a database storage analytical unit using wireless or cabled connectivity that performs the analysis and reacts to the results.

31. The method of claim 29 where the activation/reading/storage device is passed over or near the pipeline to accumulate data and transfer the data to a database storage analytical type unit that performs the analysis and reacts to the results by providing operating instructions.

32. The method of claim 29 where the activation/reading/storage device is passed over or near the pipeline to accumulate data and analyzes it using onboard database storage analytical type unit software and wirelessly or via cable reacts to the results by transmitting instruction to a pipeline supervisory control and data acquisition system.

33. The method of claim 29 where a comparison of humidity readings, temperature, gas or liquid composition or pressure inside the host pipe is used to identify a potential leaking condition in the composite pipe.

34. The method of claim 29 where a comparison of positional information is used to show movement of the pipeline.

35. The method of claim 29 wherein strain readings are analyzed to provide a measure of pipeline integrity.
